(19) United States
(12) Patent Application Publication
(10) Pub. No.: US 2013/0008823 A1
(43) Pub. Date: Jan. 10, 2013

(54) HIGH BIOMASS CONTENT BIODEGRADABLE THERMOPLASTIC MATRIX FOR FOOD CONTACT SERVICE ITEMS

(75) Inventor: Yang Hu, State College, CA (US)

(73) Assignee: Trellis Earth Products, Inc., Wilsonville, OR (US)

(21) Appl. No.: 13/179,049

(22) Filed: Jul. 8, 2011

(51) Int. Cl. B65D 85/00; C08L 3/00

(52) U.S. Cl. 206/524.1; 524/52

(57) ABSTRACT

Biodegradable bioplastic food contact service items are formed of a high biomass content bioplastic compound. Preferred embodiments of biodegradable bioplastic food contact service items each comprise a thermoplastic matrix that includes a main thermoplastic medium and a matrix material ingredient. The main thermoplastic medium is a combination of three synthetic polymers that form a functional material component into which biomass material can be blended. The three synthetic polymers are polypropylene, ultralow molecular weight polyethylene, and low density polyethylene; and the matrix material ingredient includes a polysaccharide compound in an amount of at least 50 percent by weight. Exemplary embodiments of the food contact service item use corn starch as a preferred polysaccharide compound.

### COPYRIGHT NOTICE

© 2011 Trellis Earth Products, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This disclosure relates to plastic food contact service items and, in particular, to a food contact service item formed of a high biomass content bioplastic compound.

### BACKGROUND INFORMATION

Traditional plastic bags, food containers, and food contact service items require large amounts of energy and raw materials (natural gas, oil, and coal) to produce and recycle. Oil is energy intensive to process and creates products that contribute to intractable toxic waste problems. Upon decay or combustion, the carbon content of the product is returned into the atmosphere. Although fossil fuels have their origin in ancient biomass, they are not considered biomass because they contain carbon that has been “out” of the carbon cycle for a very long time. Incorporating biomass into plastics can greatly reduce the amount of oil used to make a product.

Hydrocarbon molecules in plant mass are similar to molecules in petroleum-based products. Plant mass may, therefore, be used to displace petrochemicals in the production of plastics, while the characteristics of the plastic are retained. Biomass fillers and polysaccharide compounds such as starches can be incorporated and polymerized into plastic molecules, thereby greatly reducing the demand to consume petrochemicals while making containers and service items used in the food service industry or sheeting used for wrapping, bagging, and packaging. Eventually removing all oil by-products from plastics would be impossible—even growing corn requires petroleum-based energy. Nevertheless, plant-based materials contribute to a reduction in use of petroleum-based products.

Biomass refers to living and recently living biological material used as fuel or industrial production—fibers, chemicals, or heat. Biomass may also include biodegradable wastes that can be burned as fuel but excludes organic material that has been transformed by geological processes into substances such as coal or petroleum. Biomass is part of the carbon cycle. Carbon from the atmosphere is converted into biological matter by photosynthesis.

The introduction of biomass into materials that have always been made as pure petrochemicals, and their derivatives, helps conserve precious oil resources while improving the ecology of the waste stream. Various degrees of biodegradability, coupled with the generally sustainable nature of farming, creates a double benefit for using bioplastics when compared with the benefit of conventional plastic.

Bioplastics are biodegradable; and, in some cases, compostable plastics derived from renewable raw materials such as starch from corn, potato, tapioca, or other plants and vegetables, combined with biodegradable and conventional polymers, create products that reduce the impact on the environment. Products made from primarily biomass are considered sustainable because they participate in the carbon cycle with a lower impact than conventional petroleum products do.

### SUMMARY OF THE DISCLOSURE

Biodegradable bioplastic food contact service items each comprise a material composition-binding thermoplastic matrix. The thermoplastic matrix includes a main thermoplastic medium and a matrix material ingredient. The main thermoplastic medium is a combination of three synthetic polymers that form a functional material component into which biomass material can be blended. The three synthetic polymers are polypropylene, ultralow molecular weight polyethylene, and low density polyethylene; and the matrix material ingredient includes a polysaccharide compound present in an amount of at least 50 percent by weight to form a high biomass content bioplastic compound. A preferred polysaccharide compound is of a homopolysaccharide type that includes glucose units. Exemplary embodiments of the food contact service item use corn starch as the preferred polysaccharide compound. The food contact service item also includes ethylene-vinyl acetate in an amount sufficient to enhance waterproof competency and heat resistance of the item and an aluminum-titanium complex coupling agent that enhances the compatibility between the corn starch and synthetic polymers.

Additional aspects and advantages will be apparent from the following detailed description of preferred embodiments, which proceeds with reference to the accompanying drawings.

### BRIEF DESCRIPTION OF THE DRAWINGS

FIG. 1 is a block diagram showing the compounding ingredients sequentially added in accordance with a predesignated temperature profile in different zones of a twin-screw extruder in the production of starch-containing resin pellets embodying the disclosed biodegradable thermoplastic matrix.

FIG. 2 is a pictorial view of a thermo-molded fork processed from the disclosed starch-containing resin pellets by an injection molding machine.

FIG. 3 is a block diagram showing the processing of the starch-containing resin pellets produced in the extrusion system of FIG. 1 in accordance with a predesignated temperature profile in different zones of a single-screw sheet extruder in the production of starch-containing cast sheets or films embodying the disclosed biodegradable thermoplastic matrix.

FIGS. 4A, 4B, 4C, 4D, and 4E are diagrams of, respectively, a five-partition tray, a three-section folding food container, a three-section plate, a drinking cup, and a bowl processed from the disclosed cast sheet by a thermoforming machine.

### DETAILED DESCRIPTION OF PREFERRED EMBODIMENTS

Table 1 below presents the formulation and activity summary of compounding ingredients used to make in an extrusion system 10 starch-containing resin pellets embodying the disclosed biodegradable thermoplastic matrix.

TABLE 1

| | Symbol Ref. | | |
|---|---|---|---|
| | and wt. % Range | Description | Activity |
| Zone 1 | PP | Polypropylene (PP, Melt | Strengthen mechanical support |
| | 25-50% | Index 1-3 Ultra low | (tough and stiff) and provide heat |
| | | molecular weight | resistance and chemical resistance. |
| | | polyethylene (ULMWPE | |
| | | or PE-WAX) | |
| Zone 3 | GMS | Glycerol Monostearate | Surfactant, plasticizer, a protective |
| | 0.5-2.0% | (GMS, 2,3- | coating for hygroscopic surface. |
| | | Dihydroxypropyl | |
| | | octadecanoate) | |
| | Al—Ti | Aluminum &Titanium | Enhance compatibility between starch |
| | 0.1-2.5% | Complex Couple Agent | and synthetic polymers, and improve |
| | | (OL-AT1618) | processing properties. |
| | | (Al(or)ₙ(OOCR″)₃₋ₙ | |
| | | (Ti(OR′)ₘ(OOCR″)₄₋ₘ | |
| | ULWMPE | Ultra low molecular | Provide lubrication and decrease the |
| | 1.0-3.5% | weight polyethylene | processing temperature (melt point or |
| | | (ULMWPE or | T_{g}) of compounding. |
| | | PE-WAX) | |
| | EVA | Ethylene-vinyl acetate | Enhance waterproof competency, |
| | 2.0-10.0% | (EVA) (VA > 25%) | increase softness and flexibility and |
| | | | provide heat resistance. Used as an |
| | | | adhesive. |
| | Ti-Diox | Titanium pigment | Provide white color to product. |
| | 0.5-2.0% | (titanium dioxide) R902 | |
| | LDPE | Low Density Polyethylene | Improve flow properties of molten |
| | 1.0-5% | (LDPE, Melt Index 1-3) | compounding inside the extruder. |
| | Modifier | Starch Modifier (benzoyl | Used as an antiseptic. |
| | 0.01-0.1% | peroxide) | |
| | DLTP | Antioxidant (dilauryl | Antioxidant |
| | 0.1-0.5% | thiodipropionate, DLTP) | |
| | TMDBHM | Antioxidant 1010 (tetrakis- | Antioxidant |
| | 0.01-0.1% | [methylene (3,5-di-tert- | |
| | | butyl-4- | |
| | | hydroxyhydrocinnamate)]methane) | |
| | CaCO₃ | Calcium Carbonate | Intensifier and filler |
| | 1.0-5.0% | | |
| | Talcum | Talcum Powder | Intensifier and filler |
| | 0.1-0.5% | | |
| Zone 4 | CS | Corn Starch | Matrix material ingredient |
| | 50-65% | | |

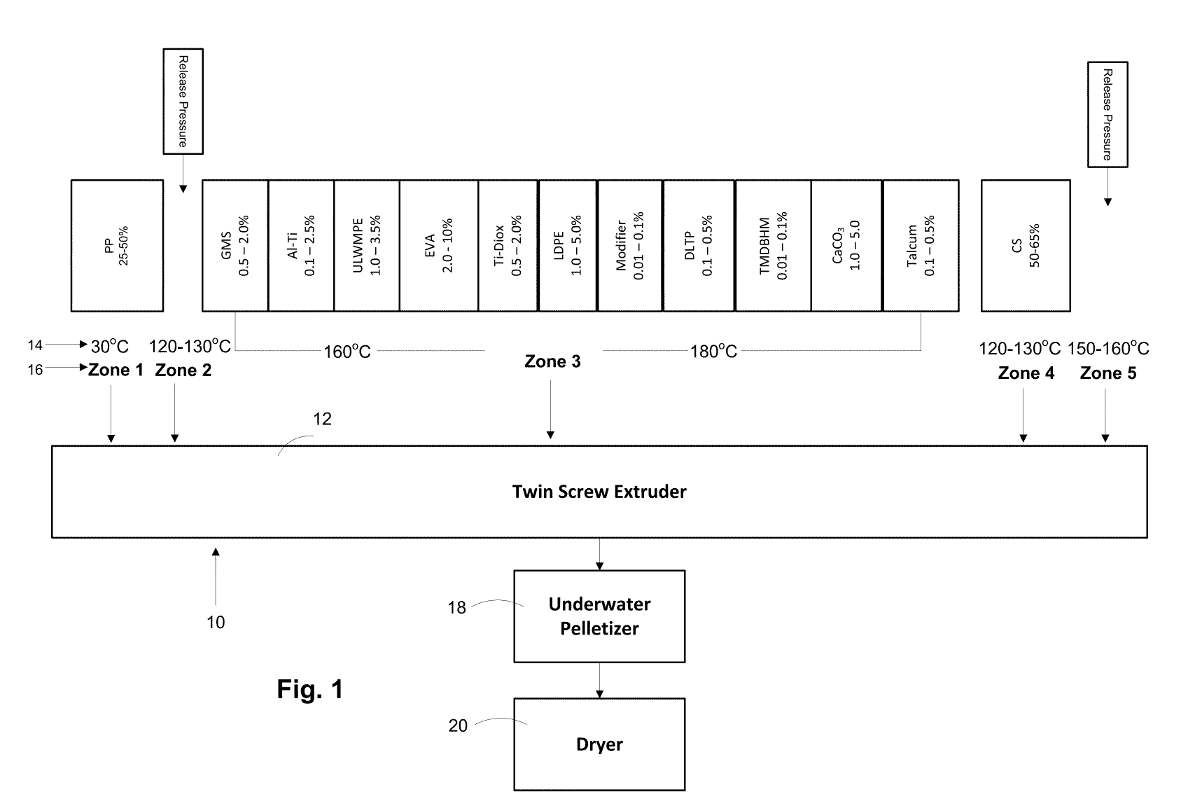

FIG. 1 is a block diagram of extrusion system 10, in which a twin-screw extruder 12 carries out in accordance with a predesignated temperature profile 14 the production of the starch-containing resin pellets. With reference to FIG. 1, temperature profile 14 of twin-extruder 12 and the particular order of addition of compounding ingredients fall into five zones 16. Temperature profile 14 along the extruder barrel from a first feedstock hopper (at Zone 1) to an output die (at Zone 5) is set to 30° C., 120-130° C., 160-180° C., 120-130° C., and 150-160° C. at Zone 1, Zone 2, Zone 3, Zone 4, and Zone 5, respectively. The torque requirement of the screws is set between 60-80 N·m, which causes the compounding material to exhibit high tensile strength, good flexibility, and lower melt viscosity. The screw rotation speed is controlled to 350-500 rpm. The ratio of length-to-diameter of each screw is set at an index of 28-33, and the entire length of each screw is set at 1.5-1.8 m. The feeding speed of the entire compounding material is 700 kg/h. The feeding speeds of adding individual ingredients depend upon the percentage of each ingredient in the formulation. All feeding speeds are controlled by automated machine hardware. One suitable twin-screw extruder is a Model E-53, manufactured by ENTEK Manufacturing, Inc., Lebanon, Oreg.

Zone 1 corresponds to the addition of PP (25-50 wt. %) at 30° C. During the increase in temperature, PP is gradually molten in Zone 2 until 160° C. The molten PP mixes with other additives across an area of temperature transition. The temperature gradient established across this area of gradual heating prevents the adverse influence of extruder equipment material aging that would be caused by a rapid increase in temperature. The feeding speed for PP is 17.5-350 kg/h. The pressure accumulated from the current extrusion is released upon conclusion of processing in Zone 2.

All the additives are fed in Zone 3 in a temperature range from 160-180° C., the Zone 3 containing GMS (0.5-2.0 wt. %; 3.5-14 kg/h of feeding speed), Al—Ti coupling agent (0.1-2.5 wt. %; 0.7-17.5 kg/h of feeding speed), ULWMPE (1.0-3.5 wt. %; 7.0-24.5 kg/h of feeding speed), EVA (2.0-10 wt. %; 14-70 kg/h of feeding speed), Ti-Diox (0.5-2.0 wt. %; 3.5-14 kg/h of feeding speed), LDPE (1.0-5.0 wt. %; 7.0-35 kg/h of feeding speed), modifier (0.01-0.1 wt. %; 0.07-0.7 kg/h of feeding speed), antioxidant DLTP (0.1-0.5 wt. %; 0.7-3.5 kg/h of feeding speed) and TMDBHM (0.01-0.1%; 0.07-0.7 kg/h of feeding speed), and fillers (CaCO₃, 1.0-5.0 wt. % with 7.0-35 kg/h feeding speed and Talcum, 0.1-0.5 wt. % with 0.7-3.5 kg/h of feeding speed). The PP, ULMWPE, and LDPE are three constituent synthetic polymers added in Zones 1 and 3 to form a main thermoplastic medium of a thermoplastic matrix. ULMWPE and LDPE are macromolecules with low molecular weight and can be easily biodegraded by a biologically eroding process in a relatively short period of time, as compared to the biodegradation time of polyethylene. The thermoplastic matrix does not melt in normal food packaging circumstances, such as pasteurization at 71.7° C. for 15-20 seconds, ultra-high temperature processing at 135° C. for 1-2 seconds, or irradiation processing including infrared heating and pulsed UV light.

The main thermoplastic medium is blended with corn starch in Zone 4. Corn starch is a preferred polysaccharide compound that functions as a matrix material ingredient. Starch is a polysaccharide consisting of anhydroglucose units (AGU) and can be produced by all green plants as an energy store. Starch is widely available and is the most common carbohydrate in the human diet. Most commonly sources of starch used worldwide are cereal crops, such as maize (corn), wheat, and rice. Other sources of starch are plant roots and tubers, such as potato and cassava. Maize (corn) starch can be considered as one of the least expensive starch sources available in the United States.

The temperature is decreased from 160-180° C. to 120-130° C. where the main thermoplastic medium exits Zone 3 and enters Zone 4. Corn starch with 6-15 wt. % water content (50-65 wt. % is added at Zone 4. The feeding speed of corn starch in Zone 4 is 350-455 kg/h. As the temperature is increased to 140-150° C. after the compounding material exits Zone 4 and enters Zone 5, the corn starch is molten and blended with pre-molten PP, ULMWPE, and LDPE and with the other additives delivered to the die at Zone 5. The pressure accumulated as a result of the extrusion processing is released in Zone 5. The die temperature in Zone 5 is kept at 100° C., ready for pelletization.

The minimum amount of starch present in the bioplastic compound is 50% by wt. The main thermoplastic medium imparts thermoplastic characteristics and viscosity to the blend with starch. The PP provides stiffness to a food surface contact item made from the thermoplastic matrix. PP also resists alkali formation in the presence of acidic foods. The ULMWPE enhances the thermoplastic properties of starch by decreasing its melting temperature so that the starch will not burn. The LDPE enhances the flexibility of starch and of the thermoformed plastic. The Al—Ti coupling agent enhances the compatibility of the PP and starch combination.

Post-extrusion pelletization uses a spring-loaded underwater pelletizer 18, in which a molten bioplastic compound emerges from the die at Zone 5 and is immediately cut into pellets by spring-loaded rotating blades under temperature-controlled water. The cutting blades of the underwater pelletizer can be, for example, of a Coperion, Farrel, JSW, or Kobe type. The cutting speed can be determined in terms of pellet sizes. The pellets typically vary from 1 mm to 4.75 mm. A Black Clawson Converting Machinery Pelletor, manufactured by Davis-Standard, LLC, Pawcatuck, Conn., is a suitable machine for performing this function. The temperature-controlled water immediately quenches and solidifies the cut pellet. In turn, the water transports the pellets to a dryer 20 where they are dried. Each spring-loaded cutter blade is formed of six spokes extending from a cutter hub and has a specified hardness 45-55 HRC. The cutter blade speed of rotation is controlled at 100-1000 rpm, depending on the throughput and desired size of compound material pellets.

Dryer 20 uses a honeycomb rotary dehumidifier to dehydrate the pellets. Hot air, instead of direct contact with a hot working table, is used to absorb moisture from pellets to prevent destruction or re-gelatinization of the starch-containing resin during the long period of dehydration.

The following example is a preferred material composition of starch-containing resin pellets embodying the disclosed biodegradable thermoplastic matrix.

### Example

| Weight Percent | Ingredient |
|---|---|
| 29% | PP |
| 0.8% | Glycerol monostearate |
| 1.00% | Al/Ti Coupling Agent |
| 2% | PE WAX |
| 5% | EVA |
| 1% | Titanium Dioxide |
| 3% | LDPE |
| 0.02% | Benzoyl peroxide |
| 0.20% | Antioxidant DLTP |
| 0.05% | Antioxidant 1010 |
| 3% | Calcium carbonate (800 mesh) |
| 1% | Talcum powder |
| 55% | Corn Starch |

A bioplastic product made from the starch-containing resin pellets having greater than 50 wt. % biomass (i.e., starch) content exhibits several properties. Such properties include moisture control resulting in no air bubbles; suitability as a food contact material; lower cost resulting from the higher starch content; manufacturability using extrusion; amenability to calendering, thermal formation, and injection molding processes; flexibility; heat resistance to 116° C.; shelf life of over one year; biodegradability; and capability of remelting in an ancillary extrusion system for calendering into rollstock.

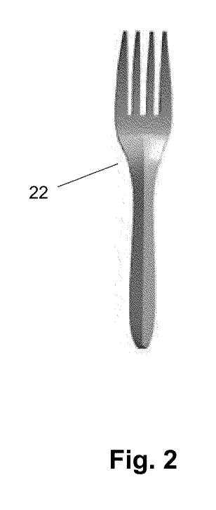

A common type of injection molding machine, such as a Model SE-HDZ manufactured by Sumitomo (SHI) Plastics Machinery (America), LLC, Norcross, Ga., is capable of processing the starch-containing resin pellets into thermo-molded forks, knives, spoons, and similar such utensils for single use food consumption. FIG. 2 shows a thermo-molded fork 22 processed from starch-containing resin pellets by an injection molding machine.

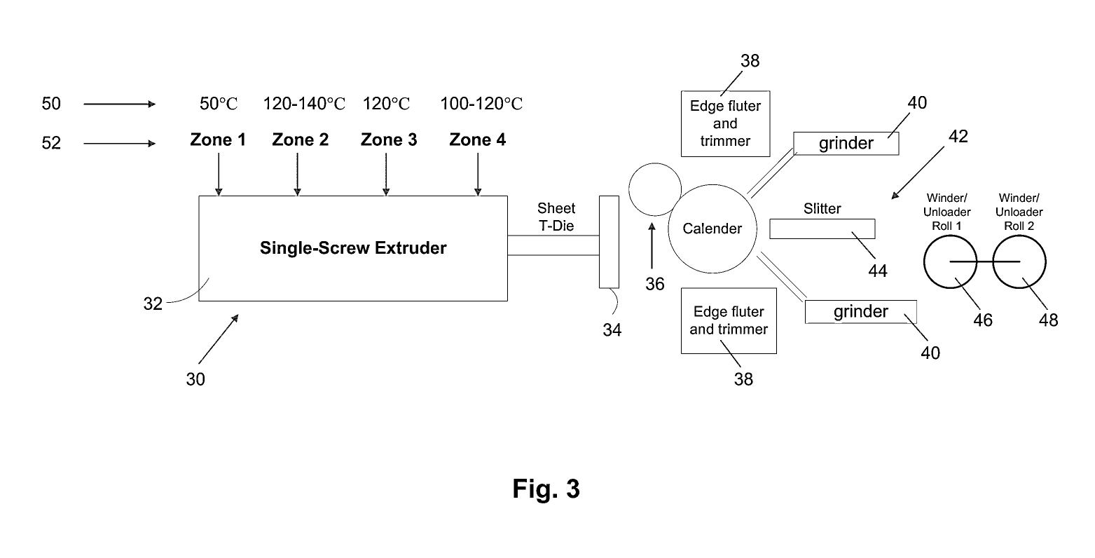

FIG. 3 is a block diagram of an ancillary extrusion system 30 in which the starch-containing resin pellets produced by extrusion system 10 are delivered for processing into a sheet or “rollstock” material. Ancillary extrusion system 30 includes a single-screw sheet extruder 32 with a filter (not shown) and a flat or sheet T-die 34 installed, a set of calendar rollers 36, edge fluters and trimmers 38 installed so that each edge of the cast sheet is positioned adjacent an edgegrinder 40, and a pull-off unit 42 composed of a slitter 44 and winder/unloader rolls 46 and 48. Slitter 44 cuts the cast sheet lengthwise to provide two sheets of the desired widths that are wound on rolls 46 and 48. The cast sheets produced by ancillary extrusion system 30 have an average thickness of 0.45 mm, ranging from about 0.5 mm to about 3.0 mm.

A temperature profile 50 of single-screw extruder 32 falls into four zones 52. Temperature profile 50 along the barrel of extruder 32 from a feedstock hopper (at Zone 1) to an output die (at Zone 4) is set to 50° C., 120-140° C., 120° C., and 100-120° C. at Zone 1, Zone 2, Zone 3, and Zone 4, respectively. Temperature profile 50 is found to be appropriate to avoid boiling at flat die 34 but still maintain a viscosity low enough to produce an extensible melt. The diameter of the extruder screw is set at 0.12 m. The ratio of length-to-diameter of the extruder screw is set at an index of 28-30. The feeding rate of compounding pellets is controlled to 350 kg/h, and the screw rotation speed is set at 300-350 rpm. The torque requirement of the screw varies with the feeding rate and the screw rotation speed. The torque is limited in the range from 100-300 N·m. Extruder 32 is assembled with a ventilation system. In addition, the filter is fixed between the end of extruder 32 and flat 34 die with an approximate width of 1 m to filtrate non-molten PP impurities.

The sheets extruded from flat die 34 are driven to set of rollers 36 having diameters ranging from 0.45 m to 0.5 m, including casting rolls and stripping rolls. The rotation speed of these rollers is temperature-controlled, thereby forming a continuous single layer of sheet that cools at a rate adjusted to control crystallinity.

The continuous single layer of sheet is driven into edge fluters and trimmers 38, their associated grinders 40, and slitter 44 to cut the sheet to the desired width. The air-cooling device on the grinder continues cooling the cast sheet. After passing through pull-off unit 42 and slitter 44, the cast sheet of the desired length and thickness is sent to winder/unloaded rolls 46 and 48 to roll up.

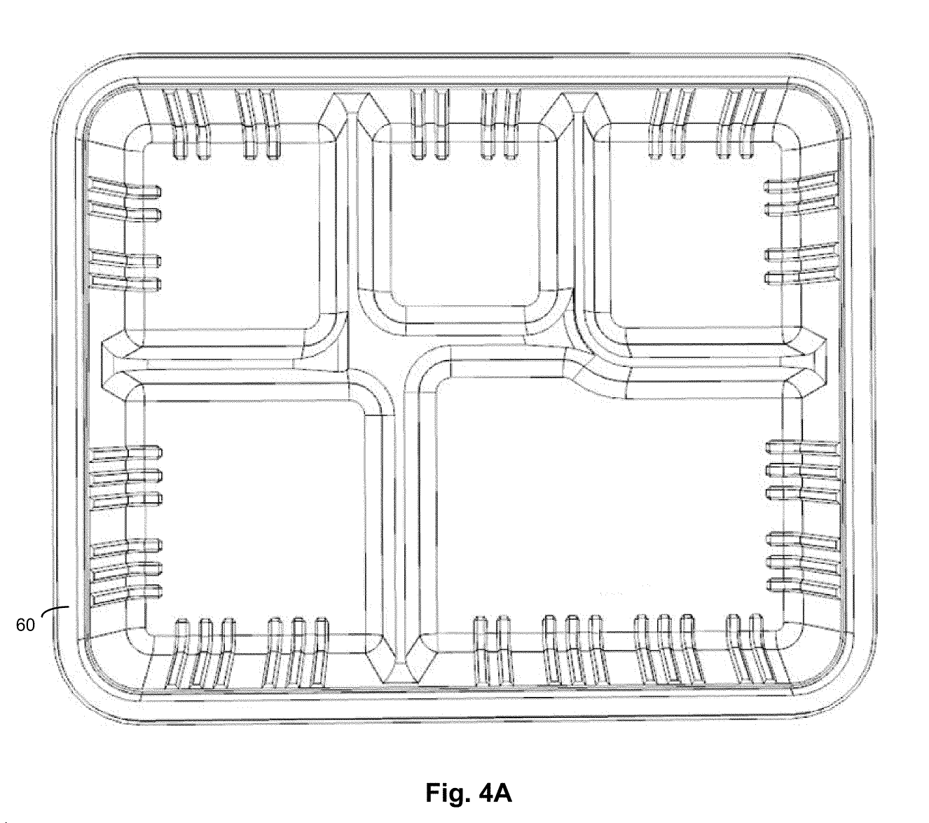

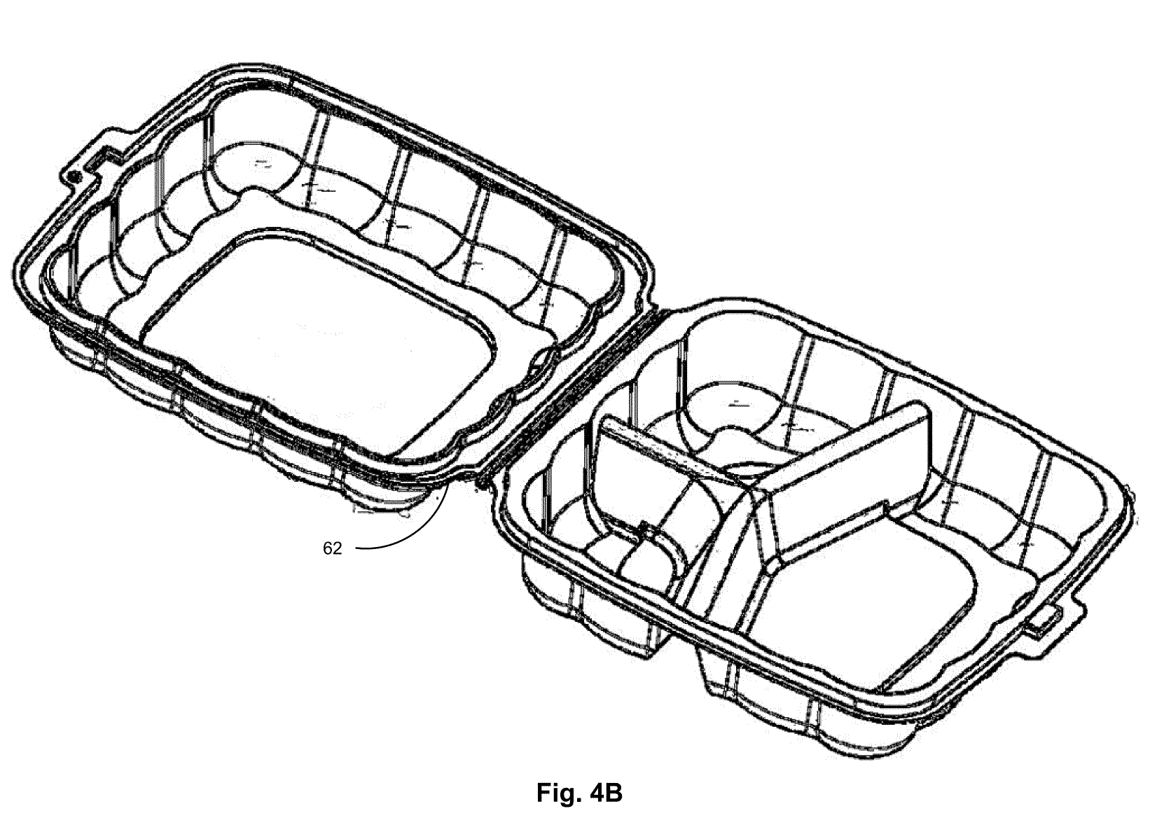

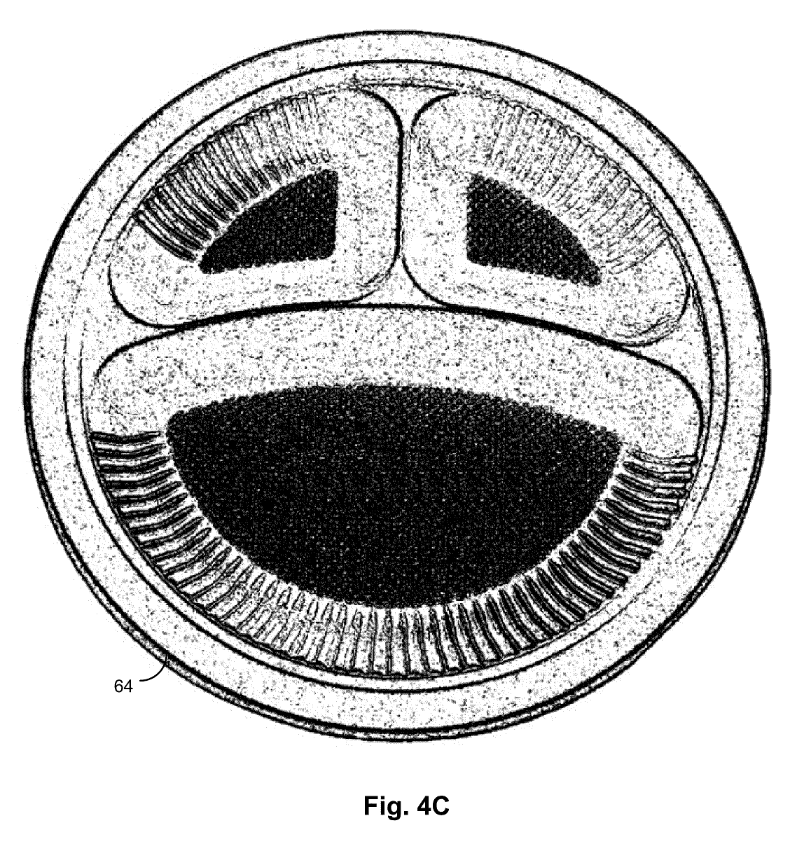

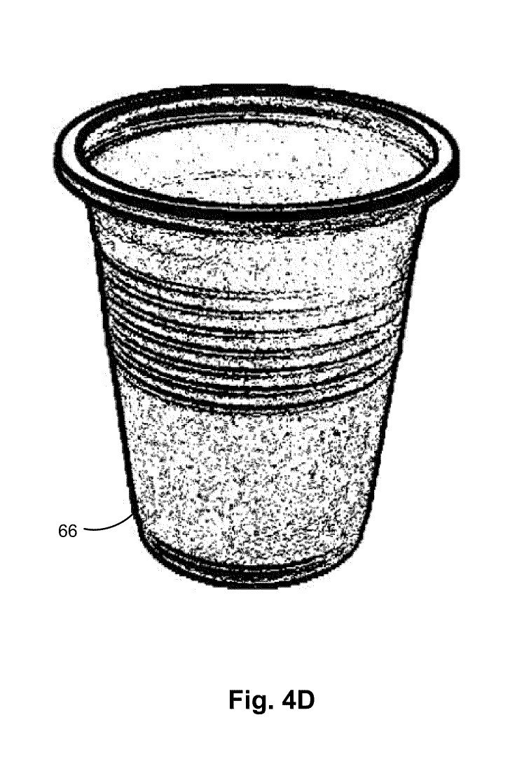

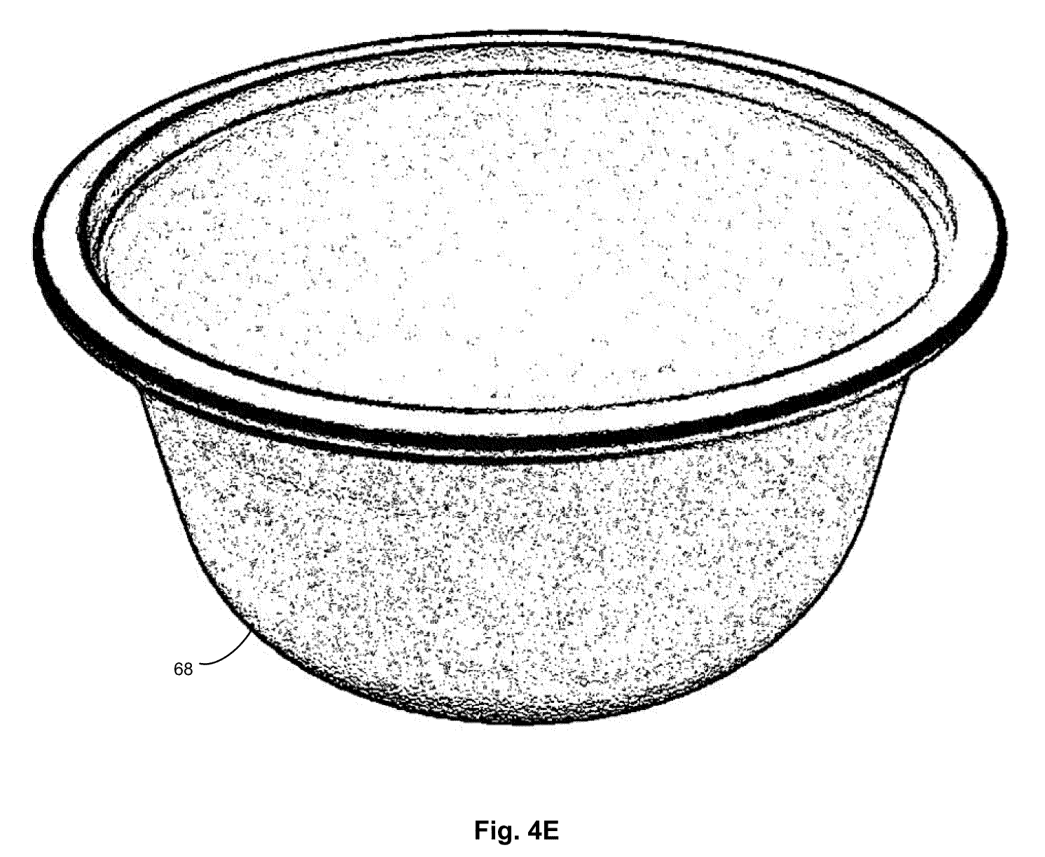

A common type of thermoforming machine, such as a Model 50ST manufactured by Irwin Research and Development, Inc., Yakima, Wash., is capable of processing this sheet material into common disposable food contact service items such as plates, trays, bowl, cups and similar items. FIGS. 4A, 4B, 4C, 4D, and 4E show, respectively, a five-partition tray 60, a three-section folding food container 62, a three-section plate 64, a drinking cup 66, and a bowl 68 processed from a cast sheet by a thermoforming machine.

It will be obvious to those having skill in the art that many changes may be made to the details of the above-described embodiments without departing from the underlying principles of the invention. The scope of the present invention should, therefore, be determined only by the following claims.

1. A biodegradable bioplastic food contact service item, comprising:
a thermoplastic matrix including a main thermoplastic medium and a matrix material ingredient, the main thermoplastic medium comprised of polypropylene, ultralow molecular weight polyethylene, and low density polyethylene; and the matrix material ingredient comprised of a polysaccharide compound present in an amount of at least 50 percent by weight to form a high biomass content bioplastic compound.

2. The biodegradable bioplastic food contact service item of claim 1, further comprising ethylene-vinyl acetate in an amount sufficient to enhance waterproof competency and heat resistance of the item.

3. The biodegradable bioplastic food contact service item of claim 2, in which the amount of ethylene-vinyl acetate is present within a range of between 2.0 and 10.0 percent by weight.

4. The biodegradable bioplastic food contact service item of claim 1, in which the polysaccharide compound is a homopolysaccharide type that includes glucose units.

5. The biodegradable bioplastic food contact service item of claim 4, in which the homopolysaccharide including glucose units is present within a range of between 50 and 65 percent by weight.

6. The biodegradable bioplastic food contact service item of claim 1, further comprising an aluminum-titanium complex coupling agent.

7. The biodegradable bioplastic food contact service item of claim 6, in which the aluminum-titanium complex coupling agent is present within a range of between 0.1 and 2.5 percent by weight.

8. The biodegradable bioplastic food contact service item of claim 1, in which the main thermoplastic medium includes polypropylene, ultralow molecular weight polyethylene, and low density polyethylene present within ranges of, respectively, 25 and 50 percent by weight, 1.0 and 3.5 percent by weight, and 1.0 and 5.0 percent by weight.

9. The biodegradable bioplastic food contact service item of claim 1, further comprising a glycerol monostearate surfactant.

10. The biodegradable bioplastic food contact service item of claim 9, in which the glycerol monostearate surfactant is present within a range of between 0.5 and 2.0 percent by weight.

11. The biodegradable bioplastic food contact service item of claim 1, in which the thermoplastic matrix is of an extruded type.

12. The biodegradable bioplastic food contact service item of claim 1 produced in the form of a tray, folding food container, plate, drinking cup, or bowl.
